(19) United States
(12) Patent Application Publication
(10) Pub. No.: US 2019/0181928 A1
(43) Pub. Date: Jun. 13, 2019

(54) SPATIAL MODULATION FOR NEXT GENERATION WIRELESS SYSTEMS

(71) Applicant: IDAC Holdings, Inc., Wilmington, DE (US)

(72) Inventors: Kyle Jung-Lin Pan, Saint James, NY (US); Fengjun Xi, San Diego, CA (US); Robert L Olesen, Huntington, NY (US); Hanqing Lou, Syosset, NY (US); Chunxuan Ye, San Diego, CA (US)

(21) Appl. No.: 16/324,443

(22) PCT Filed: Aug. 10, 2017
(86) PCT No.: PCT/US2017/046196

§ 371 Date: Feb. 8, 2019

Related U.S. Application Data
(60) Provisional application No. 62/373,296, filed on Aug. 10, 2016.

(51) Int. Cl. H04B 7/0456; H04B 7/0417; H04L 27/36

(52) U.S. Cl. CPC H04B 7/0456; H04L 27/36; H04B 7/0417

(57) ABSTRACT

Digital and hybrid spatial modulation are disclosed. A transmitting entity may be configured to perform digital or hybrid spatial modulation. In case of a digital spatial modulation, a transmitting entity may split a plurality of encoded data bits into amplitude phase modulation (APM) bits and virtual antenna index bits. The transmitting entity may modulate the APM bits into modulated data symbols. The transmitting entity may determine a virtual antenna port based on the split virtual antenna index bits and one precoding vector of a set of precoding vectors. The transmitting entity may map the modulated data symbols to a transmission layer based on the virtual antenna port. The transmitting entity may transmit the mapped modulated data symbols. In case of hybrid spatial modulation, the encoded data may be split into physical antenna index bits, and the mapped modulated data symbols may be transmitted via the physical antenna port.

### CROSS REFERENCE TO RELATED APPLICATIONS

This application claims the benefit of U.S. Provisional Application No. 62/373,296 filed Aug. 10, 2016, the content of which is incorporated herein by reference in its entirety.

### BACKGROUND

Emerging 5G systems may have one or more of the following use cases: Enhanced Mobile Broadband (eMBB), Massive Machine Type Communications (mMTC), or Ultra Reliable and Low Latency Communications (URLLC). These use cases may be based on one or more the international telecommunication union-radio (ITU-R), next generation mobile networks (NGMN), or 3rd generation partnership project (3GPP) requirements. The use cases may focus on various requirements including for example one or more of a higher data rate, higher spectrum efficiency, low power and higher energy efficiency, or lower latency and higher reliability.

Modulation techniques like spatial modulation may operate in analog domain by modulating information onto an antenna index at a transmitter. Such modulation techniques may be limited to the number of physical transmit antennas and, therefore, be less flexible and have limited spectral efficiency. Enhanced spatial modulation techniques, for example, to improve the spectral efficiency may be desirable.

### SUMMARY

Systems, methods, and instrumentalities for digital and hybrid spatial modulation are disclosed. A transmitting entity (for example, a user device or a network device) may be configured to perform digital spatial modulation. A transmitting entity may split a plurality of encoded data bits into amplitude phase modulation (APM) bits and virtual antenna index bits. The transmitting entity may modulate the APM bits into modulated data symbols. The transmitting entity may determine a virtual antenna port. The virtual antenna port may be determined based on the split virtual antenna index bits and one precoding vector of a set of precoding vectors. The set of precoding vectors may be preconfigured or may be signaled via higher layer signaling (e.g., radio resource control (RRC) signaling) or system information. The set of precoding vectors may be synchronized between a transmitting and a receiving entity. The virtual antenna port may include at least one pre-coded reference signal. The transmitting entity may select the set of precoding vectors based on information derived from the encoded data bits. The set of precoding vectors are indicated via a reference signal. The set of precoding vectors is signaled via downlink control information carried on a control channel including, for example, a new radio physical downlink control channel (NR-PDCCH), a new radio enhanced physical downlink control channel (NR-E-PDCCH), a new radio physical downlink shared channel (NR-PDSCH), etc.

The transmitting entity may map the modulated data symbols to the transmission layer. The modulated data symbols are mapped to the transmission layer based on the determined virtual antenna port. The virtual antenna port may be an indexed transmission layer. The transmitting entity transmit the mapped modulated data symbols on the transmission layer.

A transmitting entity may receive a set of feedback precoding vectors from a receiving entity. The transmitting entity may select the set of precoding vectors based on the received set of feedback precoding vectors. A transmitting entity (for example, a user device or a network device) may be configured to perform hybrid spatial modulation. A transmitting entity may split a plurality of encoded data bits into amplitude phase modulation (APM) bits, virtual antenna index bits, and physical antenna index bits. The transmitting entity may modulate the APM bits into modulated data symbols. The transmitting entity may determine a virtual antenna port, wherein the virtual antenna port is determined based on the virtual antenna index bits and one precoding vector of a set of precoding vectors. The transmitting entity may determine a physical antenna port. The physical antenna port may be determined based on the physical antenna index bits. The physical antenna port is based on an angle of arrival. The set of precoding vectors may be preconfigured or may be signaled via higher layer signaling (e.g., RRC signaling) or system information. The set of precoding vectors may be synchronized between a transmitting and a receiving entity. The virtual antenna port may include at least one pre-coded reference signal. The transmitting entity may select the set of precoding vectors based on information derived from the encoded data bits. The set of precoding vectors are indicated via a reference signal. The set of precoding vectors is signaled via downlink control information carried on a control channel including, for example, a NR-PDCCH, a NR-E-PDCCH, a NR-PDSCH, etc.

The transmitting entity may map the modulated data symbols to at least one transmission layer. The modulated data symbols are mapped based on the determined virtual antenna port. The virtual antenna port may be an indexed transmission layer. The transmitting entity may transmit the mapped modulated data symbols using the virtual antenna port via the physical antenna port.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 1E is an example illustrating discontinuous reception (DRX) operation.

FIG. 2 is a transmitter block diagram illustrating a digital spatial modulation system.

FIG. 3 is a transmitter block diagram illustrating a hybrid spatial modulation system.

FIG. 4 illustrates the flow chart for hybrid spatial modulation with multi-stage processing.

FIG. 5 illustrates hybrid spatial modulation with multi-stage processing.

FIG. 6 illustrates an example of hybrid spatial modulation with quadrature amplitude modulation (QAM).

FIG. 7 illustrates an example of angle of arrival (AoA) index-based spatial modulation.

FIG. 8 illustrates a physical channel transmission block diagram.

FIG. 9 illustrates an exemplary spatial modulation mapping table.

FIG. 10 illustrates an exemplary reference signal design for an analog spatial modulation system.

FIG. 11 illustrates an exemplary transmission diagram for reference signals.

FIG. 12 illustrates an exemplary transmission of reference signals and data symbols.

FIG. 13 illustrates an exemplary transmission of reference symbols using unused antennas.

FIG. 14 illustrates an exemplary hybrid spatial modulation system.

FIG. 15 illustrates an exemplary reference signal design for hybrid spatial modulation system.

FIG. 16 illustrates multi-level power saving for spatial multiplexing and various types of spatial modulations with on/off radio frequency (RF) chains and baseband (BB) circuitries.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

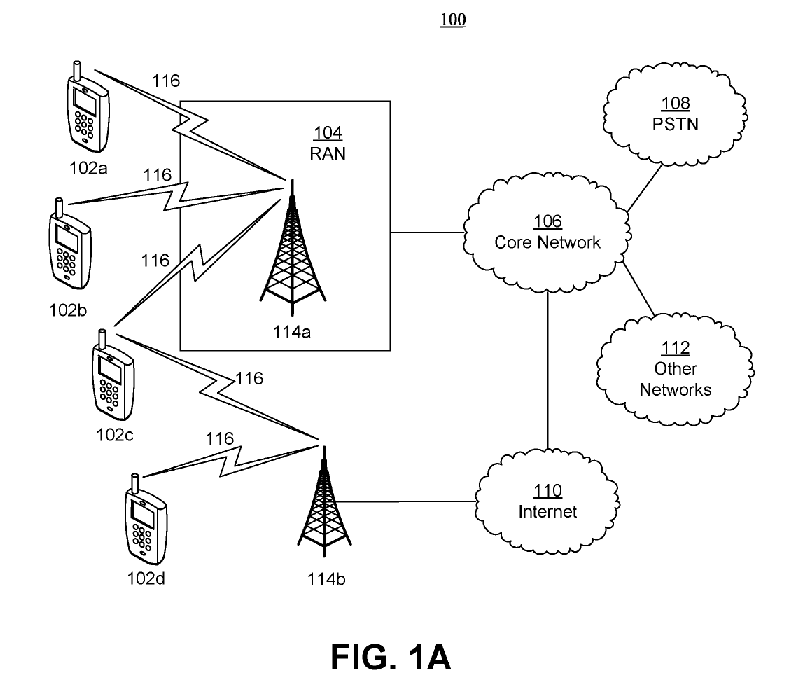

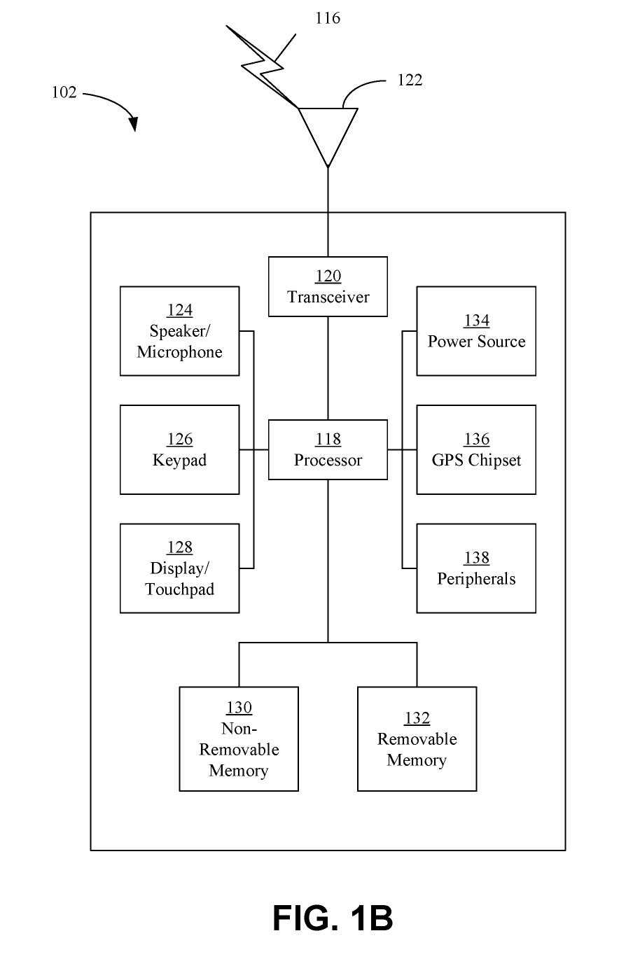

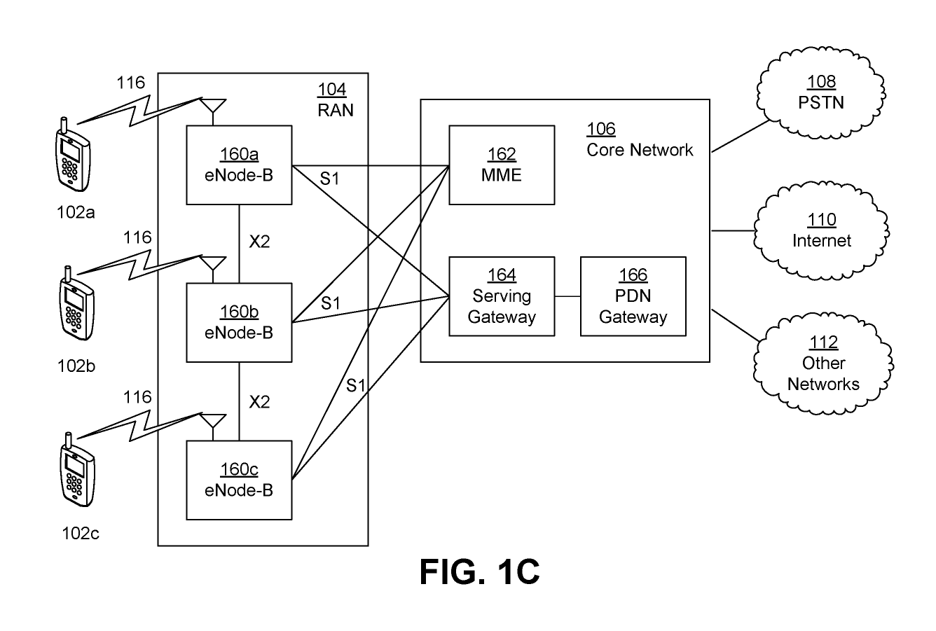

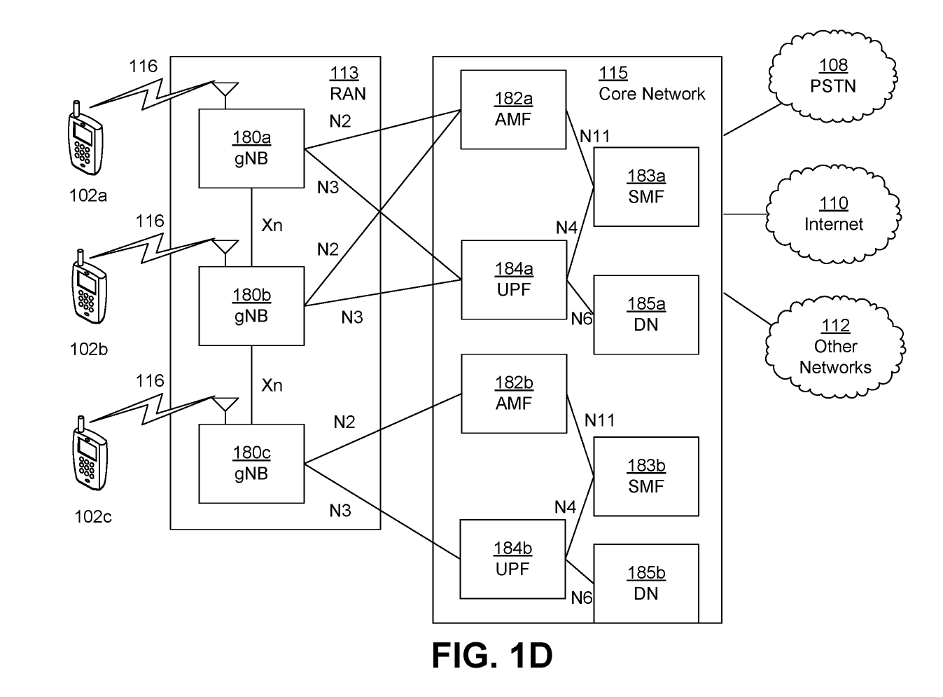

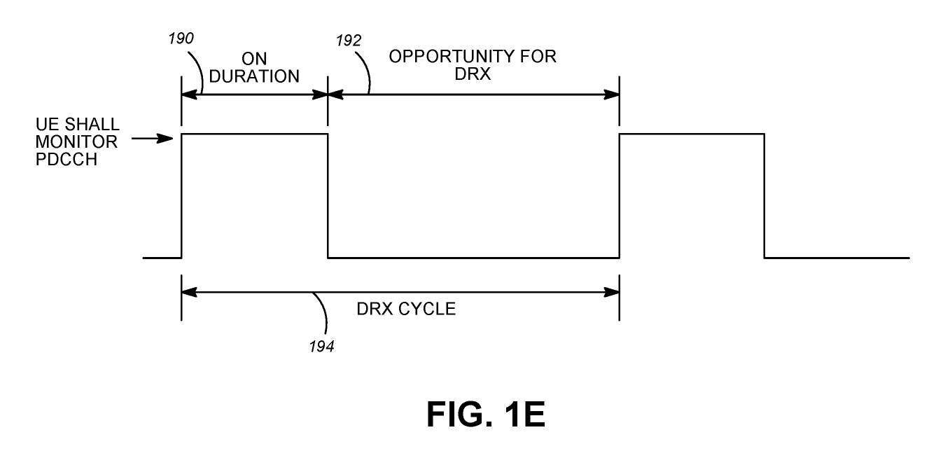

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the Si interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Spatial modulation MIMO (SM-MIMO) may be a modulation technique that modulates information onto a plurality of antenna indices at the transmitter allowing the number of radio frequency (RF) chains to be less than the number of transmit antennas. This may reduce overall cost and power consumption compared to MIMO. SM-MIMO may primarily target energy efficiency (EE) over spectrum efficiency (SE).

Link adaptation may be used to transmit one or more parameters that are dynamically configured, for example, based on channel conditions. Link adaptation may configure the parameter(s) to optimize certain link criteria. Adaptive modulation and coding (AMC) may be a link adaptation scheme that may be used to adjust the modulation and coding scheme based on the current channel conditions and a desired error probability, for example, to maximize the spectral efficiency (SE). Multiple input multiple output (MIMO) technology may target higher SE. Spatial multiplexing (SMX) is a MIMO technique that may allow for multiple simultaneous data streams to be transmitted and received over the same radio channel. Certain channel conditions may need to be satisfied, hence link adaptation may be applied by dynamically adjusting the SMX mode based on the current channel conditions so as to maximize the SE.

SM-MIMO may be a powerful communication technique that may target low cost devices and energy efficient operation. Link adaptation may be used to increase SE based on the changing channel conditions these systems may encounter.

Discontinuous reception (DRX) may be one of the power saving mechanisms used by a wireless transmit/receive unit (WTRU). DRX may be used in idle mode or RRC connected mode. For example, when a WTRU has no data to receive or transmit in RRC connected mode, the WTRU may switch off its transceiver for a short time interval. The WTRU may start a wake up and sleep cycle, for example, as illustrated in FIG. 1E. During the wakeup period 190 of the DRX cycle 194, for example, the WTRU may monitor the physical downlink control (PDCCH) channel for UL or DL grants, whereas the sleep periods 192 of the DRX cycle 194 may be used by the WTRU to preserve power and therefore improve the battery savings.

Designs associated with spatial modulation are disclosed. Analog spatial modulation may be limited to physical antennas and operate in analog domain with limitations. Digital domain for spatial modulation may be used. Spatial modulation may be limited to one dimension in the analog domain with restriction and less flexibility. Multi-stage and multi-dimension including digital domain may be used, e.g., for flexibility, trade-off, and optimization. Channel estimation systems and/or pilot training systems for spatial modulation may be provided. Energy saving mechanisms, e.g., with spatial modulation may be provided.

Features disclosed herein may provide for one or more of the following: digital spatial modulation, which may include different variants of digital spatial modulation; hybrid spatial modulation, which may include combined or joint digital and analog domains; channel estimation and/or pilot training systems; and/or energy-efficient and/or power-saving mechanisms. Analog spatial modulation may be interchangeably used with classic spatial modulation, conventional spatial modulation or spatial modulation throughout this disclosure.

Systems, methods, and instrumentalities for digital spatial modulation are disclosed. In analog spatial modulation activation of one or more physical antennas may bear information. Digital spatial modulation disclosed herein may use one or more virtual antennas, and index encoding of virtual antenna(s) may facilitate data transmission. In digital spatial modulation, index encoding of virtual antennas may be performed, for example, instead of and or in addition to the use of physical antennas. Using digital spatial modulation, information may be encoded at the transmitter and decoded at receiver by the identification to the use of virtual antennas.

Virtual antennas or transmission layers may be indexed by a codebook. Virtual antennas or transmission layers, or combinations thereof, may be index encoded. For example, a codebook may contain a set of indexes. The codebook may be known to both the user device and the network device or the transmitter and the receiver. The codebook may be synchronized between the user device and the network device or the transmitter and the receiver. Synchronizing the codebook may assist in encoding and decoding of information for digital spatial modulation.

For example, a digital spatial modulation system may include one or more transmitting antennas, N_{T} and one or more receiving antennas, N_{R}. One or more digital transmission layers that may be formed, which may be denoted by Nₘₐₓ_{_}_{layer}. One or more active digital layers, which may be denoted by N_{active}_{_}_{layer}. N_{active}_{_}_{layer} may be less than or equal to Nₘₐₓ_{_}_{layer}. Information bits may be encoded and carried by activating one or more N_{active}_{_}_{layer} transmission layers among Nₘₐₓ_{_}_{layer} layers. The number of information bits that may be carried and encoded may be bits.

$${log}_{2} ( \begin{matrix}{N}_{max\_layer} \\ {N}_{active\_layer}\end{matrix} )$$

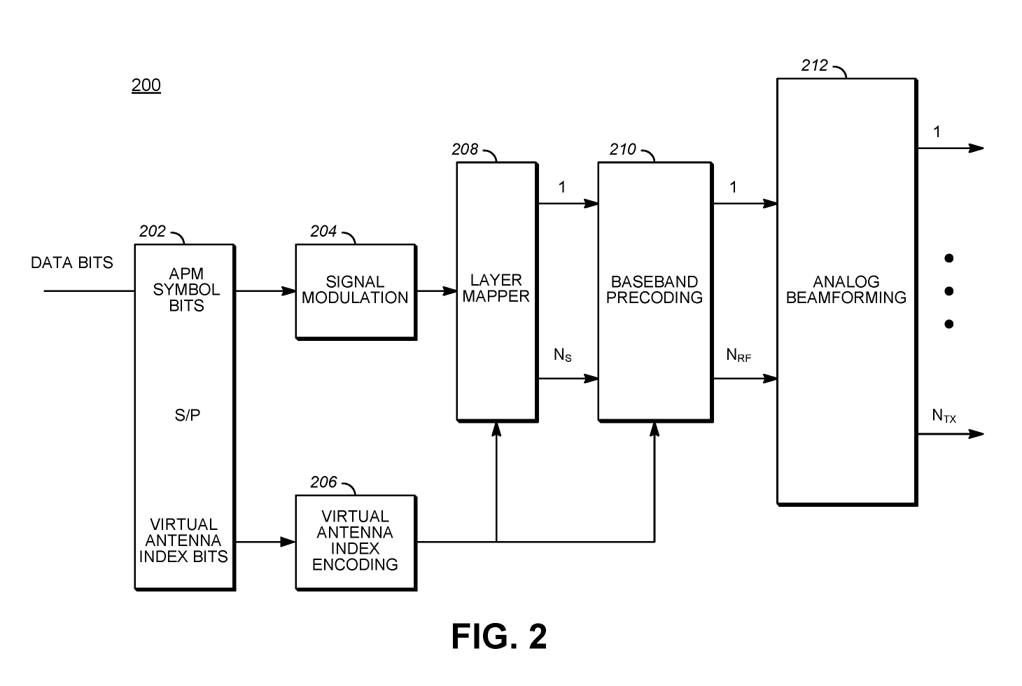

FIG. 2 is a transmitter block diagram illustrating a digital spatial modulation system 200. As illustrated in FIG. 2, a digital spatial modulation transmitter may include one or more of a serial-to-parallel block 202, a signal modulation block 204, a virtual antenna index encoding block 206, a layer mapping block 208, or a baseband precoding block 210. The analog beamforming block 212 may be included to support analog beamforming of mmW transmission beams.

As illustrated in FIG. 2. a serial-to-parallel block 202 may split data bits (e.g., encoded data bits) into two sets. The two sets may be amplitude phase modulation (APM) bits and virtual antenna index bits. The signal modulation block 204 may map the APM bits to a signal constellation, for example quadrature phase-shift keying (QPSK), 16-quadrature amplitude modulation (16-QAM), etc. The virtual antenna index bits may be index-encoded by the virtual antenna index encoding block 206. The outputs of the signal modulation block 204 and the virtual antenna index encoding block 206 may be provided as inputs to the layer mapping block 208. In the layer mapping block 208, the output of the signal modulation block 204 may be mapped to one or more transmission layers, Nₛ. The virtual antenna index bits may select the specific layers used to transmit data in the layer mapping block 208. The output of the layer mapping block 208 may be provided as an input to the baseband precoding block 210. The output of the baseband precoding block 210 may use N_{RF} baseband processing chains or RF chains to carry Nₛ transmission layers. The analog beamforming block 212 may be used to compensate for propagation loss or to enhance the signal-to-noise ratio (SNR). N_{RF} baseband processing chains or RF chains may connect to N_{TX} antennas to transmit the data signal.

Codebook index-based digital spatial modulation is disclosed. Digital layers may be represented by codewords. The codewords may be represented by a codebook. A codebook may be used at the transmitter and the receiver or the network device (e.g., an eNodeB (eNB) or a 5G NodeB (gNB)) or a user device. The transmitter may select a codeword from the codebook. The transmitter may use the selected codeword to form a transmission layer to transmit data. The transmitter and receiver may operate using one or more of an open-loop operation or a closed-loop operation. For example, a total number of codewords in a codebook may be denoted as L. A transmitter may choose L_{c} codewords from the L possible codewords. The transmitter may encode information bits using the selected codewords. By using this method,

$${log}_{2} ( \begin{matrix}L \\ {L}_{c}\end{matrix} )$$

information bits may be transmitted. The receiver may receive and decode the transmitted information bits.

The codewords and combinations of codewords may be indexed. An index of codewords and/or combinations of codewords may be known to a transmitter and a receiver. A transmitter may encode information bits into codewords or combinations of codewords. The transmitter may transmit the codeword or combination of codewords. For example, a transmitter may encode information bits 0000 into codeword 1 and information bits 0110 into a combination of codewords 1 and 4. A receiver may detect codeword 1 and decode information bits 0000 or detect combinations of codewords 1 and 4 and decode information bits 0110. Different indexing methods or index-encoding methods may be used. For example, assuming a codebook has 4 codewords, the indexing as illustrated in Table 1 may be used.

TABLE 1

| Index | Codeword combinations | Information bits |
|---|---|---|
| 1 | 1 | 0000 |
| 2 | 2 | 0001 |
| 3 | 3 | 0010 |
| 4 | 4 | 0011 |
| 5 | 1, 2 | 0100 |
| 6 | 1, 3 | 0101 |
| 7 | 1, 4 | 0110 |
| 8 | 2, 3 | 0111 |
| 9 | 2, 4 | 1000 |
| 10 | 3, 4 | 1001 |
| 11 | 1, 2, 3 | 1010 |
| 12 | 1, 2, 4 | 1011 |
| 13 | 1, 3, 4 | 1100 |
| 14 | 2, 3, 4 | 1101 |
| 15 | 1, 2, 3, 4 | 1110 |
| 16 | none | 1111 |

For open-loop operations, the transmitter may select a codeword, for example, based on information derived from data bits. For closed-loop operations, the receiver may feedback one or more best K codewords, a subset of the best K codewords, or combinations of the best K codewords. The transmitter may select a codeword or combination of codewords from the codewords or combination of codewords in the receiver's feedback report. The selected codewords may include but are not limited to the best K codewords, a subset of the best K codewords, or combinations of the best K codewords.

In an example, the best K codewords reported by the receiver may be used for close-loop operation. Closed-loop performance may be optimum compared to open-loop. Open-loop operations may be used for, but not limited to, opportunistic operations or higher mobility, while closed-loop operations may be used for, but not limited to, deterministic operations or lower mobility.

Precoding matrix indicator (PMI)-based spatial modulation is disclosed. A transmission layer may be formed by a precoding matrix or a precoding vector. A codeword may be a precoding matrix or a precoding vector. A codeword index may be represented by or included in a precoding matrix indicator (PMI), a precoding vector indicator (PVI) or a subset thereof. A transmitter (e.g., a gNB) may select and transmit one or more PMIs or PVIs. The transmitter may transmit the PMI or PVI via a downlink control channel (for example, physical downlink control channel (PDCCH), enhanced physical downlink control channel (E-PDCCH), etc.). The transmitter may transmit the PMI or PVI via a WTRU-specific reference signal (RS) (for example, a demodulation reference signal (DMRS), a pilot, etc.). For example, by selecting one PMI from L PMIs, the transmitter may encode

$${log}_{2} ( \begin{matrix}L \\ 1\end{matrix} )$$

information bits. The encoded information bits may be decoded at the receiver.

The set of PMIs used by the transmitter may be restricted, for example, based on the feedback from a user device. The receiver or the user device may report the best K PMIs. The transmitter (e.g., a gNB) may select one of the best K PMIs received from the receiver or the user device. The transmitter may encode

$${log}_{2} ( \begin{matrix}K \\ 1\end{matrix} )$$

information bits. The encoded information bits may be decoded at the receiver.

In an example, a transmitter (e.g., a gNB) may indicate the PMI used by the transmitter. The transmitter may use the PMI to carry extra information. The receiver may report a maximum number of layers that may be supported.

In an example, a receiver may report a maximum number of layers that may be supported, one or more precoding matrices associated with it. The transmitter may select one or more layers from the reported precoding matrix or matrices using information contained in the data bits.

A PMI may be carried by a receiver-specific reference signal (for example, DMRS). A precoded or beamformed reference signal may be used. The receiver may withdraw PMI information from a received WTRU-specific RS that is transmitted by the transmitter. The transmitter may select a PMI. The transmitter may select a precoded RS using the selected PMI. The transmitter may transmit the precoded RS. The transmitter may indicate the PMI used at the transmitter to the receiver. The transmitter may use the RS to carry extra information using the selection of the PMI for the RS. The receiver may decode a precoded RS and obtain the PMI embedded in the precoded RS using a detection receiver (e.g., maximum likelihood method). The receiver may decode the PMI to retrieve the information bits.

Control to enable digital spatial modulation is disclosed. Virtual antennas or virtual transmission layers may be indexed. A codebook may include a set of indices including a plurality of antenna ports or transmission layers that are known to the transmitter (e.g., a gNB) and the receiver (e.g., a WTRU). The codebook may be synchronized between the transmitter and the receiver. The codebook may be communicated between the transmitter and the receiver. The codebook may be synchronized and/or communicated using one or more of the following: higher layer configuration (e.g., via radio resource control (RRC) signaling), a notification via system information, or a globally available lookup table via, for example, a broadcast message. The codebook may be preset or hardcoded at the transmitter and receiver.

A subset of the codebook indexes may be used. Some restriction of the codebook or codebook index may be applied. Multiple codebooks may be used. Information about the codebook, the multiple codebooks, or a subset of the codebook or codebooks may be communicated between the transmitter and the receiver. The information may be communicated using one or more of the following: RRC signaling, a medium access control (MAC) control element (CE), or L1 control messages.

A transmitter (e.g. a gNB) may use a codeword, PMI, PVI or similar to transmit and encode data. Information about the codeword, PMI, or PVI, may be indicated via a control channel, or UE-specific reference signal (RS). The control channel may be instantiated using a PDCCH, E-PDCCH, or an extension thereof. The control channel may be multiplexed with the data channel using the PDSCH, or the like. The UE-specific reference signal (RS) may be a demodulation reference signal (DMRS), or may be similar to the DMRS or a reference signal method.

The receiver may report the best K codewords, PMI, PVI, portions thereof, or combinations thereof. A subset of codewords or codeword combinations may be used. A receiver may send codewords to a transmitter via an uplink control channel (for example, PUCCH, e-PUCCH, or PUSCH). Codewords may be multiplexed with UL-SCH on the PUSCH.

Systems, methods, and instrumentalities for hybrid multi-layer spatial modulation are disclosed. Hybrid spatial modulation may combine digital spatial modulation (DSM) and analog spatial modulation (ASM). An analog spatial modulation system may use a selection of transmit antennas to carry information bits. Selecting and turning on one or more antennas, or a subset of antennas, may be used to encode information. Hybrid spatial modulation as disclosed herein may use a transmission layer or selection as the first stage of processing and a physical antenna selection as the second stage of processing.

A hybrid spatial modulation based system may comprise one or more transmitting antennas, N_{TX}, and one or more receiving antennas, N_{RX}. One or more digital transmission layers that may be formed, which may be denoted by Nₘₐₓ_{_}_{layer}. There may be one or more active digital layers, which may be denoted by N_{active}_{_}_{layer}. N_{active}_{_}_{layer} may be less than or equal to Nₘₐₓ_{_}_{layer}. Information bits may be encoded and carried by activating one or more N_{active}_{_}_{layer} transmission layers among Nₘₐₓ_{_}_{layer} layers. The number of information bits that may be carried and encoded may be

$${log}_{2} ( \begin{matrix}{N}_{max \_ layer} \\ {N}_{active \_ layer}\end{matrix} )$$

bits. There may be one or more active transmitting antennas, which may be denoted by N_{TX,a}. Information bits may be encoded and carried by activating N_{TX,a} antennas from N_{TX} total antennas. The number of information bits that may be carried and encoded may be

$${log}_{2} ( \begin{matrix}{N}_{TX} \\ {N}_{TX , a}\end{matrix} )$$

bits.

Hybrid spatial modulation may have two stages—digital spatial modulation (DSM) in the first state and analog spatial modulation (ASM) in the second stage. DSM may include activating one or more N_{active}_{_}_{layer} transmission layers among Nₘₐₓ_{_}_{layer} layers. The number of information bits that may be carried and encoded using DSM may be

$${log}_{2} ( \begin{matrix}{N}_{max \_ layer} \\ {N}_{active \_ layer}\end{matrix} )$$

bits. ASM may include activating one or more N_{TX,a} antennas among N_{TX} antennas. The number of information bits that may be carried and encoded using ASM may be

$${log}_{2} ( \begin{matrix}{N}_{TX} \\ {N}_{TX , a}\end{matrix} )$$

bits. The total number of information bits from the first stage and the second stage processing that may be encoded, denoted as Q, may be determined using the following equation:

$$Q = {log}_{2} [ ( \begin{matrix}{N}_{max \_ layer} \\ {N}_{active \_ layer}\end{matrix} ) \times ( \begin{matrix}{N}_{TX} \\ {N}_{TX , a}\end{matrix} ) ] \qquad ( Equation 1 )$$

By rewriting Equation 1, Q may be expressed using the following equation:

$$Q = {log}_{2} ( \begin{matrix}{N}_{max \_ layer} \\ {N}_{active \_ layer}\end{matrix} ) \times {log}_{2} ( \begin{matrix}{N}_{TX} \\ {N}_{TX , a}\end{matrix} ) \qquad ( Equation 2 )$$

On a condition that amplitude phase modulation (APM) may be used in combination with hybrid spatial modulation, Q may be determined using the following equation:

$$Q = {log}_{2} ( \begin{matrix}{N}_{max \_ layer} \\ {N}_{active \_ layer}\end{matrix} ) \times {log}_{2} ( \begin{matrix}{N}_{TX} \\ {N}_{TX , a}\end{matrix} ) + {N}_{active \_ layer} \times {Q}_{APM} \qquad ( Equation 3 )$$

where Q_{APM} may represent the number of bits carried by APM symbols.

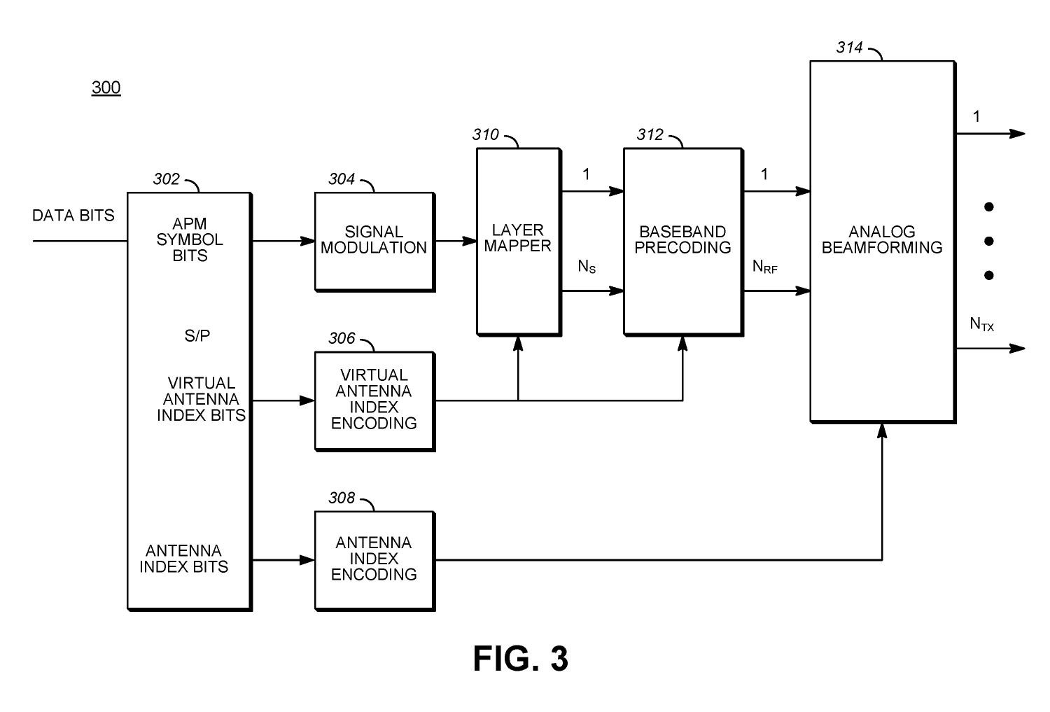

FIG. 3 is a transmitter block diagram illustrating a hybrid spatial modulation system 300. As illustrated in FIG. 3, a hybrid spatial modulation transmitter may include one or more of a serial-to-parallel block 302, a signal modulation block 304, a virtual antenna index encoding block 306, a physical antenna index encoding block 308, a layer mapping block 310, a baseband precoding block 312, or an analog beamforming block 314.

As illustrated in FIG. 3, serial-to-parallel block 302 may split data bits (e.g., encoded data bits) into three sets. The three sets may include amplitude phase modulation (APM) bits, virtual antenna index bits, and physical antenna index bits. The signal modulation block 304 may map the APM bits to a signal constellation, for example quadrature phase-shift keying (QPSK) or 16-quadrature amplitude modulation (16-QAM), etc. The virtual antenna index bits may be index-encoded by the virtual antenna index encoding block 306. The physical antenna index bits may be index-encoded by the physical antenna index encoding block 308. The outputs of the signal modulation block 304 and the virtual antenna index encoding block 306 may be input into the layer mapping block 310. The output of the physical antenna index encoding block 308 may control the transmission antenna selection.

The output of the signal modulation block 304 may be mapped to one or more transmission layers in the layer mapping block 310. The virtual antenna index bits may be used to select the specific layer or layers to transmit data. Once the number of transmission layers, Nₛ are identified in the layer mapper, they may be delivered to baseband precoding block 312. The output of baseband precoding block 312 may use N_{RF} baseband processing chains or RF chains to carry Nₛ transmission layers. N_{RF} baseband processing chains or RF chains may connect to N_{TX} antennas to transmit the data signal using one or more antennas. A physical antenna in the analog beamforming block 314, for example, may be chosen based on the antenna index bits and the output of the antenna index encoding block 308.

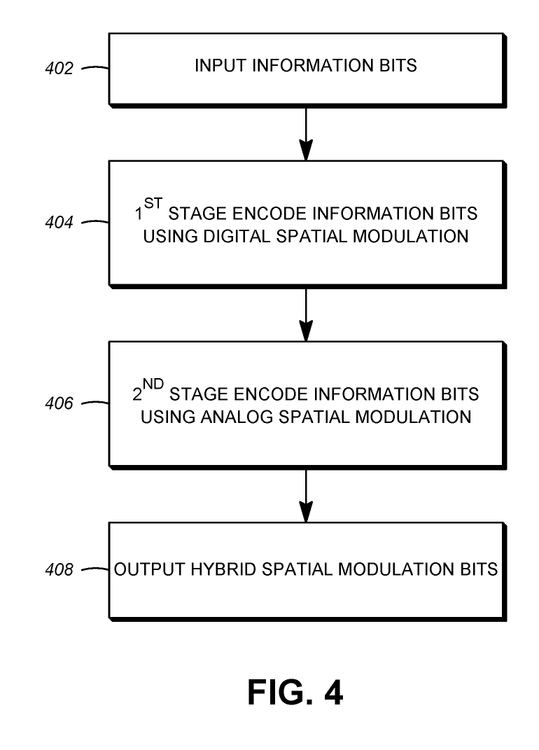

FIG. 4 illustrates hybrid spatial modulation with multi-stage processing. As illustrated in FIG. 4, at 402, information bits may be input into a transmitter. The information bits may be encoded. At 404, the information bits may be encoded using a digital spatial modulation as disclosed herein. At 406, an additional set of information bits may be encoded using an analog spatial modulation method as disclosed herein. At 408, the output may be bits that may be modulated using a hybrid spatial modulation as described herein. The output may be in the form of transmission layers and antennas.

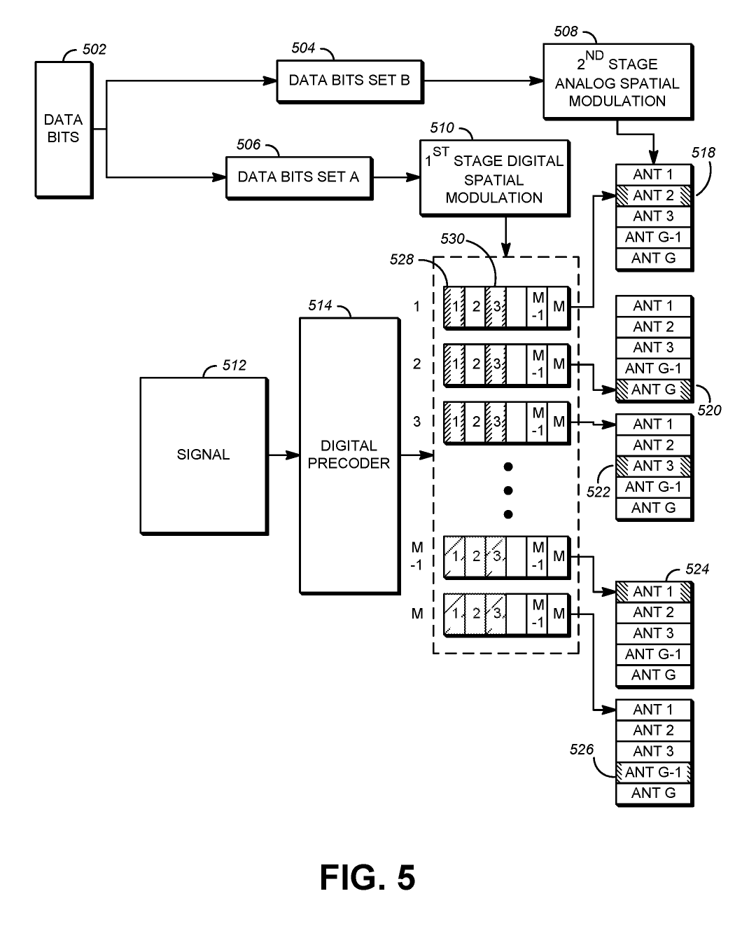

FIG. 5 illustrates hybrid spatial modulation with multi-stage processing. As illustrated in FIG. 5, input data bits 502 may be split into data bits set A 506 and data bits set B 504. The data bits set A may be used for a first stage digital spatial modulation 510 and the data bits set B may be used for a second stage analog spatial modulation 508.

As illustrated in FIG. 5, a signal 512 may be first digitally precoded using the digital precoding unit 514. For the first stage digital spatial modulation, the digitally precoded signal may be mapped to transmission layer 1 (528) and transmission layer 3 (530) for each of the rows 1 to M. For the second stage, different antennas may be selected for each of the rows 1 to M. For example, antenna ANT 2 (518) may be selected for transmission for row 1, antenna ANT G (520) may be selected for transmission for row 2, ANT 3 (522) may be selected for transmission for row 3, ANT 1 (524) may be selected for transmission for row M−1, and ANT G−1 (526) may be selected for transmission for row M.

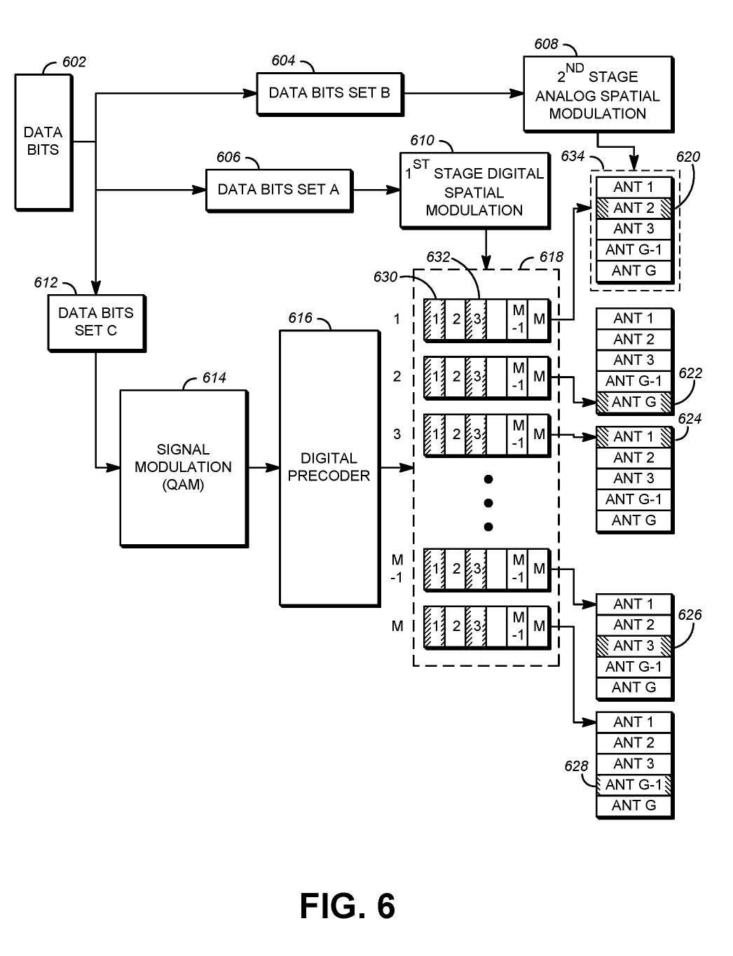

FIG. 6 illustrates an example of hybrid spatial modulation with QAM. As illustrated in FIG. 6, input data bits 602 may be split into data bits set A 606, data bits set B 604, data bits set C 612. The data bits set A may be used for a first stage digital spatial modulation 610 and the data bits set B may be used for a second stage digital spatial modulation 608.

As illustrated in FIG. 6, data bits set C 612 may be modulated using signal modulation 614, for example, QAM. The modulated symbols after passing through digital precoder 616 may be modulated using the first stage digital spatial modulation 610, followed by the second stage analog modulation 608. After performing digital precoding, the digitally precoded signal may be mapped to transmission layer 1 (630) and transmission layer 3 (632) for each of the rows 1 to M. As further illustrated in FIG. 6, at second stage, different antennas may be selected for each of the rows 1 to M may be selected. For example, antenna ANT 2 (620) may be selected for transmission for row 1, antenna ANT G (622) may be selected for transmission for row 2, ANT 1 (624) may be selected for transmission for row 3, ANT 3 (626) may be selected for transmission for row M−1, and ANT G−1 (628) may be selected for transmission for row M.

Systems, methods, and instrumentalities for angle-of-arrival (AoA) index-based spatial modulation are disclosed. AoA may be ranked, indexed, and/or used to encode and bear information. Beamforming may be used to focus energy on a desired AoA. For example, a transmitter and a receiver may have multiple antennas. The channel between the transmitter and receiver may be known to the transmitter and the receiver. Based on the number of receiver antennas and antenna aperture size, the 360 degrees of AoA may be partitioned into several sectors, say A sectors. For example, the first sector may cover the AoA of [b₀, b₁]. The second sector may cover the AoA of [b₁, b₂]. The A-th sector may cover the AoA of [b_{A-1}, b_{A}=b₀+360].

Information about how the total possible angles of arrival are partitioned may be synchronized between the transmitter and the receiver. The information may be periodically adjusted. The adjustment may be based on one or more channel conditions. The information may be synchronized via higher layer signaling, for example, via radio resource control (RRC) signaling. The information may be synchronized using an RRC connection reconfiguration message.

Each sector or a combination of sectors may be mapped to certain data information. There may be at most 2^{A}−1 possible combinations of sectors. Mapping from a sector combination to data may cover up to A bits of information. The transmitter may adjust its transmitted beam by using analog, digital, or hybrid beamforming, for example such that the AoA at the receiver side is associated with the information bits.

For example, if A is 4, there may be four sectors of AoA. The four sectors may correspond to a₁ (for example, covering angles [0, 90]), a₂ (for example, covering angles [90, 180]), a₃ (for example, covering angles [180, 270]), and a₄ (for example, covering angles [270, 360]). The mapping from the combinations of sectors to information may be an AoA-index table, for example, as is illustrated in Table 2.

TABLE 2

| | Sector combination | | | | | | | |
|---|---|---|---|---|---|---|---|---|
| | a₁ | a₂ | a₃ | a₄ | a₁, a₂ | a₁, a₃ | a₁, a₄ | a₂, a₃ |
| Information | 0000 | 0001 | 0010 | 0011 | 0100 | 0101 | 0110 | 0111 |
| bits | | | | | | | | |

| | Sector combination | | | | | | |
|---|---|---|---|---|---|---|---|
| | a₂, a₄ | a₃, a₄ | a₁, a₂, a₃ | a₁, a₂, a₄ | a₁, a₃, a₄ | a₂, a₃, a₄ | a₁, a₂, a₃, a₄ |
| Information | 1000 | 1001 | 1010 | 1011 | 1100 | 1101 | 1110 |
| bits | | | | | | | |

For example, if a transmitter has the information bits 1010 to be transmitted, the transmitter may beamform in such a way that received angles have the AoA in sectors a₁, a₂, and a₃ simultaneously. The AoA may be in the range of [0, 90], [90, 180], and [270, 360]. The beamforming may be based on the transmitter's knowledge of the physical channel between the transmitter and the receiver.

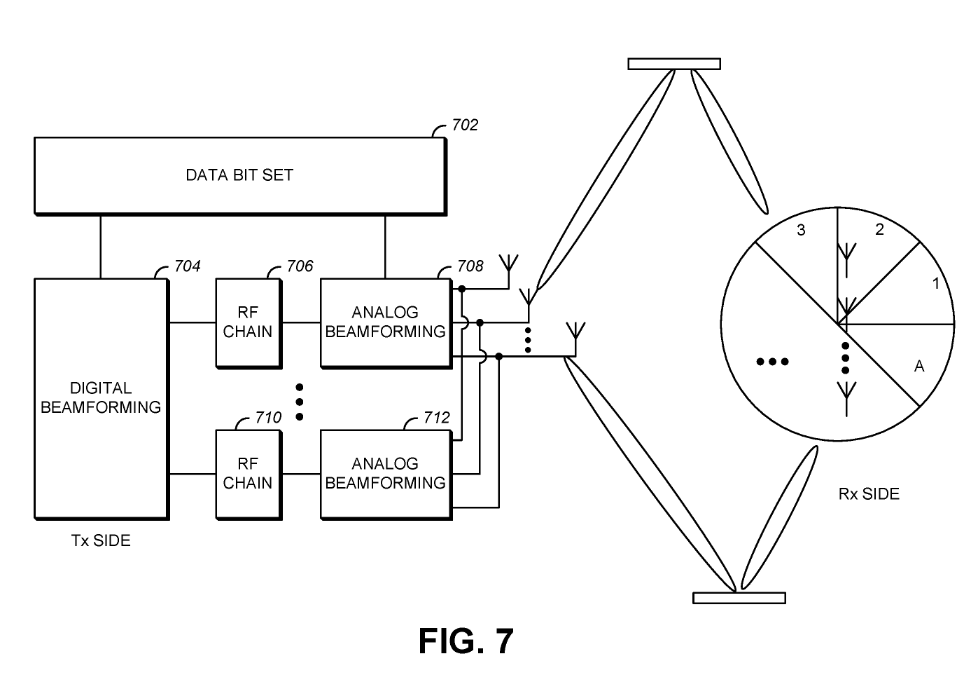

FIG. 7 illustrates an example of AoA index-based spatial modulation. AoA may be used as the index for spatial modulation. Zenith angle of arrival (ZoA) may be used as the index for spatial modulation instead of or in addition to an AoA index method. ZoA indexing method and AoA indexing methods may be used independently or together to carry additional information bits. In this example, data may be represented by the use of data bits to select an AoA spatial modulation source. An AoA virtual index-based modulation may be used. The virtual index-based modulation may be used instead of a virtual antenna index. For example, 702 separates bits (e.g., encoded bits) into AoA index bits, and data bits for transmission over AoA transmission beams. Hybrid beamforming may be used. Hybrid beamforming may be performed by digital beamforming unit 704 and analog beamforming units 708 to 712. Analog beamforming may be used to form one or more virtual AoA beams that are selected using a virtual index-based modulation. The digital beamforming may be used for transmission of the data bits over the selected AoA beams. RF chains 706 to 710 may be used for the modulation of data bits formed by digital beamforming unit 704 into RF beams.

AoA may be ranked (for example, from highest to lowest). The AoA and combinations thereof may be index-encoded using a table, for example, as described in Table 2. If there are four AoA sectors AoA1, AoA2, AoA3 and AoA4, 24−1 combinations of sectors may be possible. If no AoA is included as an information-bearing option, there may be 24 combinations. A signal may be beamformed to focus energy on an AoA or combinations thereof. Information may be encoded using different AoAs or combinations thereof. K AoAs may bear K information bits. If a signal is beamformed to focus energy on a sector, the signal may encode and bear

$${log}_{2} ( \begin{matrix}K \\ 1\end{matrix} )$$

bits. Apart from the AoA, the angle of departure (AoD), other angle information, multipath, or combinations thereof may be used.

AoA index-based spatial modulation or ZoA index-based spatial modulation may be used in combination with analog spatial modulation (e.g., used for transmit antenna selection). Using AoA/ZoA index-based spatial modulation may facilitate an increase of spectrum efficiency of the spatial modulation scheme.

Transmission mode for spatial modulation may be provided. A transmission mode may be configured by higher-layer signaling (e.g., RRC configuration signaling), other signaling methods as described herein. A transmission mode for spatial modulation may be introduced and configured as described herein.

In an example, a transmission mode, TMx may be used for spatial modulation. Such transmission mode, TMx may be configured by the RRC. The control information of switching between different types of spatial modulation (for example, DSM, ASM, or hybrid spatial modulation (HSM)) may be signaled by an L1 control channel (for example, PDCCH). Different types of spatial modulation may be indicated by, for example, TMx_a bits in a DCI field. A DCI format (for example, an existing or a new DCI format) may be used. The DCI format may be used for reserving and interpreting TMx_a bits. The TMx_a bits may consist of 2 bits.

In an example, more than one new transmission modes may be used. Transmission modes may indicate different types of spatial modulation, for example, including DSM, HSM, and ASM. Transmission modes may be configured and signaled by higher-layer signaling (e.g., RRC signaling) or other signaling mechanisms, as disclosed herein.

Layer mapping for spatial modulation may be performed. Signal modulation (e.g., APM or QAM symbols) may be mapped to one or more transmission layers. Transmission layers may include, for example, elevation, azimuth, polarization, or beams. Virtual antenna index bit or bits may select the specific transmission layer or a combination of layers that may be used to transmit the symbols (e.g., APM or QAM symbols). The type and number of transmission layers may be determined by a layer mapper. The type and number of transmission layers may be a function of virtual antenna index bits or index, TBS, MCS, etc.

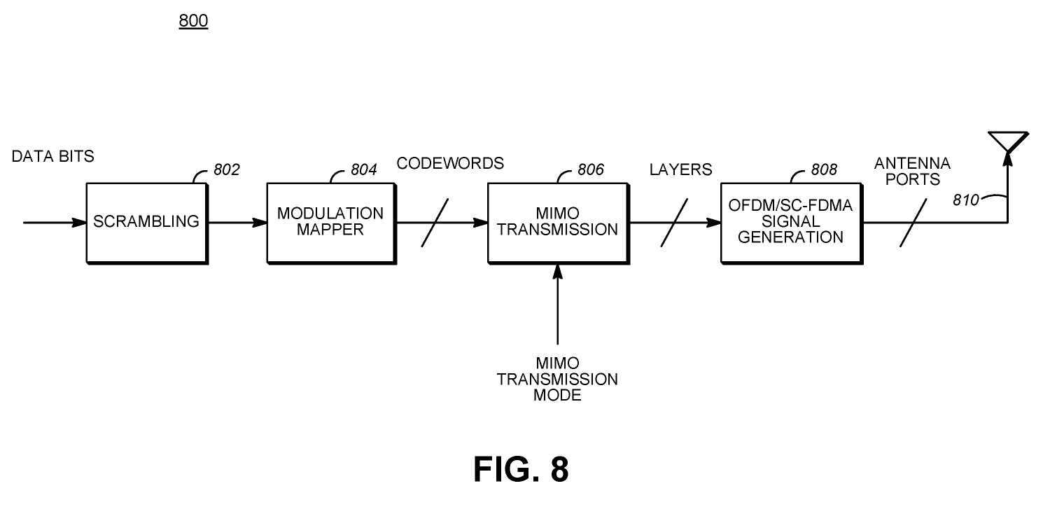

FIG. 8 illustrates a block diagram of a physical channel transmission block diagram 800. A baseband signal representing downlink and/or uplink physical channels may be defined as described herein. As illustrated in FIG. 8, at 802, data bits, for example, encoded bits may be scrambled in each codeword. The codewords may be transmitted on a physical channel. At 804, the scrambled bits may be modulated to generate complex-valued modulation symbols. At 806, MIMO transmission modes for up to L_{c} codewords and up to Nₘₐₓ_{_}_{layer} transmission layers may be used. Digital spatial modulation may be carried out with a MIMO transmission mode. The complex-valued modulation symbols may be mapped onto one or more transmission layers. Transform precoding may be used to generate complex-valued symbols. Precoding of the complex-valued modulation symbols on each layer for transmission on antenna ports may occur. The precoded complex-valued symbols may be mapped to resource elements. At 808, complex-valued time-domain OFDM signals may be generated for each of the antenna ports 810.

For MIMO transmission, one or more modes of operation to support spatial modulation may be provided. The mode of operation used may depend on whether 1) no spatial modulation, 2) digital spatial modulation (DSM), 2) hybrid spatial modulation (HSM) or 4) analog spatial modulation (ASM) is used.

For example, the following uplink transmission schemes may be supported: DSM with MIMO transmission, ASM with MIMO transmission, and HSM with MIMO transmission. These transmission schemes may be signaled by L1 control message or L2 control message. For this mode, the specification of the antenna port may be independent of the spatial modulation scheme. For example, a transmission mode may include a New Radio 3GPP Release 14 or 15 transmission mode, and may support the spatial modulation schemes, as disclosed herein.

One or more transmission modes may be used to support spatial modulation for uplink transmission, for example, as illustrated in Table 3. The transmission modes may include a single-antenna port transmission with single port spatial modulation and precoding, and a multi-antenna port transmission with multi-port spatial modulation and precoding. The use of spatial modulation and precoding may be defined as a specific transmission mode that may be indicated to a user device or a receiver using a DCI in a downlink control channel. One or more DCI modes (for example, DCI modes 3 and 4, as illustrated in Table 3) may be supported that may include one or more of a single-antenna port, a multi-antenna port, spatial modulation or precoding transmission modes.

A user device or a wireless transmit/receive unit (WTRU) may be semi-statically configured via higher layer signaling (e.g., using an RRC message) to transmit new radio physical uplink shared channel (NR-PUSCH) transmissions based on the WTRU and gNB capabilities. These capabilities may be signaled via a control channel (e.g., a PDCCH, E-PDCCH, NR-PDCCH, or NR-ePDCCH) according to one of several uplink transmission modes. As illustrated in Table 3, for example, four uplink transmission modes (transmission mode 1, 2, 3, and 4) may be provided to support spatial modulation. A chosen mode out of the four modes may indicate the subset of uplink transmission schemes that may be used for a WTRU. For example, as channel conditions change, NR-PUSCH transmissions for the same WTRU application may change (e.g., dynamically change) among the transmission schemes allowed by the transmission mode. The transmission mode may be indicated by DCI formats via, for example, PDCCH, E-PDCCH, NR-PDCCH, or NR-ePDCCH.

TABLE 3

| Trans- | | | |
|---|---|---|---|
| mission | DCI | | Transmission scheme of PUSCH |
| mode | format | Search Space | corresponding to PDCCH |
| Mode 1 | DCI | Common and | Single-antenna port, port 10 |
| | format 0 | UE specific | |
| | | by C-RNTI | |
| Mode 2 | DCI | Common and | Single-antenna port, port 10 |
| | format 0 | UE specific | |
| | | by C-RNTI | |
| | DCI | UE specific | Closed-loop spatial multiplexing |
| | format 4 | by C-RNTI | |
| Mode 3 | DCI | Common and | Single-antenna port, single-port |
| | format A | UE specific | spatial modulation, port 101 |
| | | by C-RNTI | |
| Mode 4 | DCI | Common and | Single-antenna port, multi-port |
| | format B | UE specific | spatial modulation, port 101 |
| | | by C-RNTI | |
| | DCI | UE specific | Multi-antenna port, multi-port |
| | format C | by C-RNTI | spatial modulation, port 201 |

A WTRU may decode the NR-PDCCH and transmit the corresponding NR-PUSCH, for example, if a WTRU is configured by higher layers to decode NR-PDCCHs with the cyclic redundancy check scrambled by a cell radio network temporary identifier (C-RNTI). The WTRU may decode the NR-PDCCH and transmit the corresponding NR-PUSCH, for example, if the C-RNTI is indicated in the NR-PDSCH. The scrambling initialization of the NR-PUSCH that may correspond to one or more NR-PDCCHs and the NR-PUSCH retransmission for the same transport block may be based on C-RNTI.

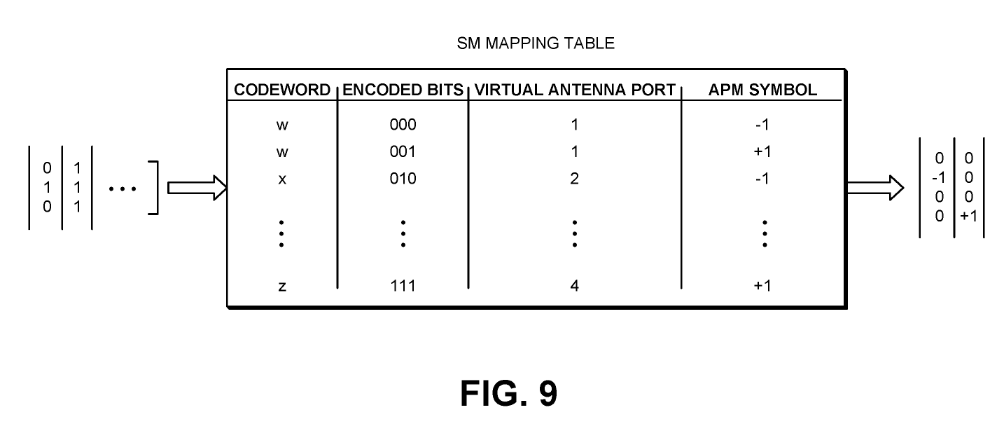

Spatial modulation may be enabled through the use of a spatial mapping table. An exemplary spatial modulation mapping table is provided in FIG. 9. As illustrated in FIG. 9, the first two bits of a number of coded input bits may be used to indicate a virtual antenna port (e.g., virtual antenna port number 1, 2, 3, or 4). The virtual antenna port may indicate a transmission layer. The third bit of the coded input bits may be an APM symbol bit. The APM symbol bit may be modulated based on an APM modulation scheme. The APM modulation scheme may be signaled, for example, via DCI. For example, as illustrated in FIG. 9, BPSK may be used as the modulation scheme where a coded input bit 1 may be modulated to symbol +1, and coded input bit 0 may be modulated to symbol −1. The APM symbol may be carried and transmitted on the virtual antenna port indicated by the virtual antenna index bits. The spatial mapping table may be predefined, specified, or signaled. For example, the spatial mapping table may be signaled via RRC message or by L1 control (for example, via DCI).

The index to a mapping table may be indicated by DCI and carried on NR-PDCCH. For example, the index may be included in a NR-PDCCH at the beginning of a self-contained uplink sub-frame for subsequent transmission of the uplink NR-PUSCH. An indication for open or closed-loop operation may be provided in the corresponding downlink DCI. The indication may be included in a NR-PDCCH. The indication in NR-PDCCH may be accompanied by a spatial modulation mapping table index, or it may include a reference to a spatial modulation mapping table index.

A transmit device (e.g., at a user device or a network device) may be configured to perform a method of digital spatial modulation as disclosed herein. A WTRU acting as a transmit device may be configured to receive a set of precoding vectors (e.g., codewords) to form virtual antenna ports. The number of precoding vectors may be based on the number of virtual antenna ports used for spatial modulation. The set of precoding vectors may be configured or indicated in a WTRU-specific manner. The set of precoding vectors may be a subset of a predefined codebook. One or more precoded reference signals may be used for spatial modulation. Each precoded reference signal may be a virtual antenna port. The WTRU may receive a time/frequency resource (e.g., a resource element) for transmission. The WTRU may split bits in the resource into two sets. The two sets may be APM bits and virtual antenna index bits. The WTRU may determine a virtual antenna port to transmit a data symbol. The WTRU may determine the virtual antenna port based on information bits associated with the time/frequency resource. The WTRU may transmit the data symbols associated with the virtual antenna ports (e.g., precoded reference signals) based on the set of precoding vectors.

A transmit device may be configured for hybrid spatial modulation (HSM), as described herein. An HSM transmission procedure may include DSM and ASM. The HSM transmission procedure may combine the functionality of hybrid spatial modulation with that of analog spatial modulation. HSM may leverage the benefits of DSM and ASM in a procedure that combines the HSM procedure and the ASM procedure.

Systems, methods, and instrumentalities for channel estimation and pilot training are disclosed. Channel estimation for analog spatial modulation is disclosed. Spatial modulation where physical antenna indices may convey information may be referred to as analog spatial modulation. In a system based on analog spatial modulation, reference signals for demodulation may be transmitted over physical antennas. Reference signals for demodulation may be presented in a dedicated time slot, which may be used for reference signals (e.g., only for reference signals). Modulated data symbols may be transmitted using a subset of physical antennas, and/or a subset of RF chains, and may be transmitted after the dedicated reference signal time slot. Reference signals and data signals may be separated in time. Power efficiency from spatial modulation transmission may be obtained within a data symbol transmission time slot.

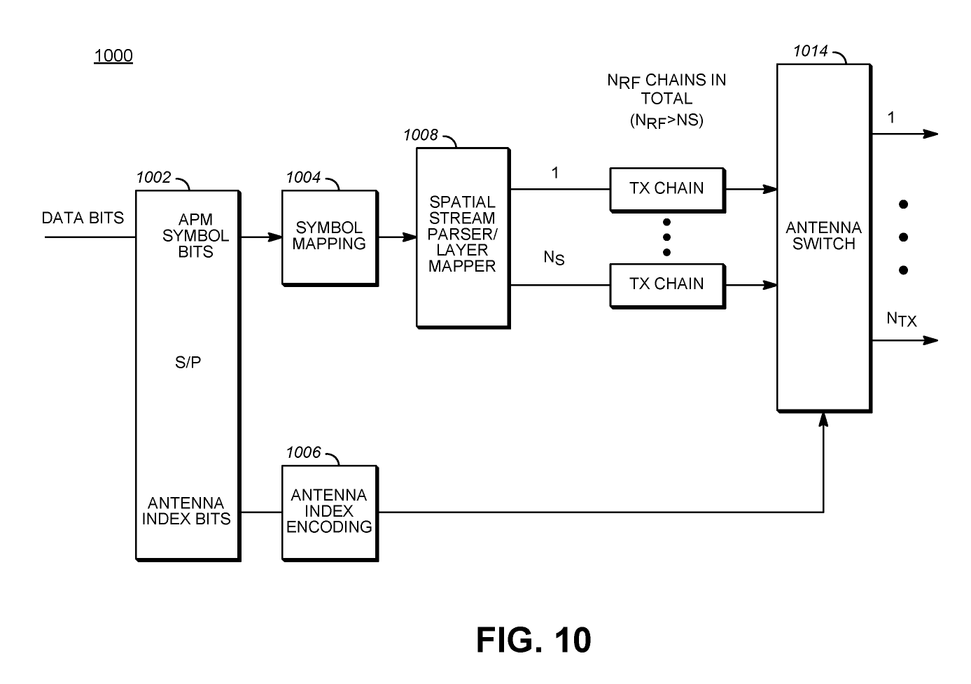

FIG. 10 illustrates an exemplary reference signal design 1000 for an analog spatial modulation system. N_{TX} physical antennas and N_{RF} radio frequency (RF) frontend chains may be available at a transmitter. Data symbols may be coded and modulated as illustrated in FIG. 10. As illustrated in FIG. 10, the S/P block 1002 may split data bits (e.g., encoded data bits) into APM symbol bits and antenna index bits. The symbol mapping block 1004 may modulate APM symbol bits into modulated symbols. The antenna index encoding block 1006 may encode the antenna index bits. The spatial stream parser/layer mapper 1008 may map the modulated symbols into Ns data streams. The transmitter may transmit Ns data streams using analog spatial modulation, and extra bits may be carried by spatial modulation (e.g., antenna) index encoding. Ns may be less than or equal to N_{RF}, and N_{RF} may be less than or equal to N_{TX}. Several combinations may be available to convey the antenna index bits. The number of combinations may depend on the antenna index encoding algorithm and associated implementation.

For example, the RF chains may be fixed to a group of physical antennas. An antenna switch 1014 may be enabled by the RF chain switch.

$$( \begin{matrix}{N}_{RF} \\ {N}_{s}\end{matrix} )$$

combinations may be available to carry antenna index bits. Channel estimation may be required for N_{RF} virtual channels. In an example, each RF chain may be switchable between physical antennas.

$$( \begin{matrix}{N}_{TX} \\ {N}_{s}\end{matrix} )$$

combinations may be available to carry antenna index bits. Channel estimation may be needed for N_{TX} physical channels.

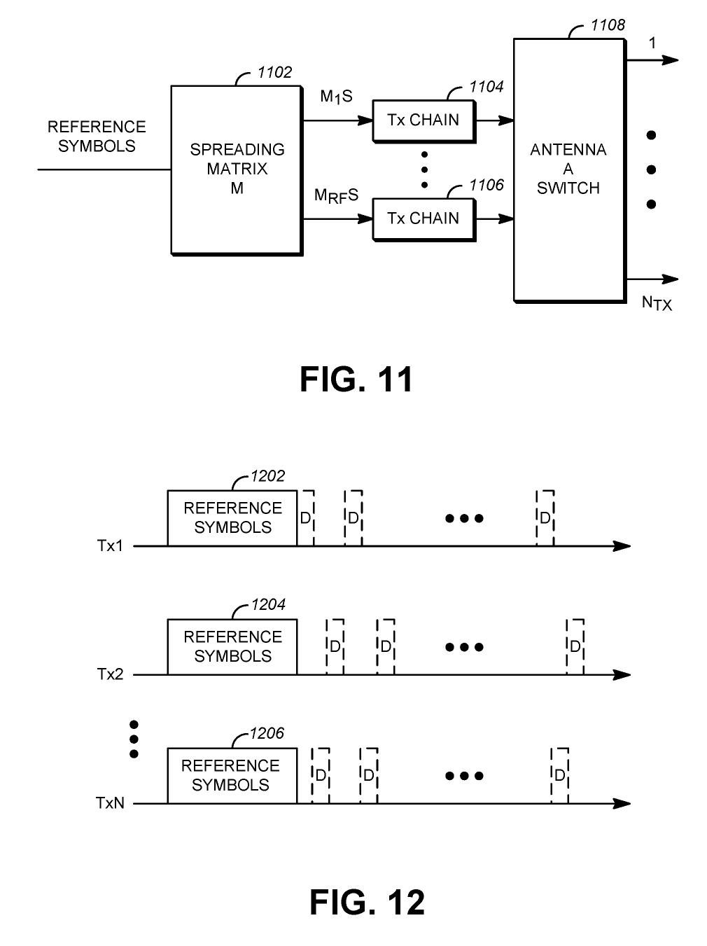

Reference symbols may be used for a receiver to estimate the channel from one or more possible transmit RF chains/transmit antennas and perform demodulation. FIG. 11 illustrates an exemplary transmission diagram for reference signals. As illustrated in FIG. 11, reference symbols may be passed to a spreading matrix 1102 of size Nₐ×N_{b}. A reference symbol s may be spread to Nₐ spatial streams and N_{b} time slots. The spatial streams may be transmitted using TX chains 1104 to 1106, using N_{TX} transmit antennas that are connected to an antenna switch 1108. The spreading matrix 1102 may be a standard matrix or signaled (e.g., signaled before transmission), such that the spreading matrix 1102 is available at the transmitter and at the receiver. For example, if Nₐ is equal to N_{TX}, and N_{b} is equal to N_{TX}. The spreading matrix M may be equal to

$$[ \begin{matrix}{M}_{11} & ⋯ & {M}_{1 , {N}_{TX}} \\ ⋮ & ⋱ & ⋮ \\ {M}_{{N}_{TX} , 1} & ⋯ & {M}_{{N}_{TX} , {N}_{TX}}\end{matrix} ] .$$

In an example, N_{TX} may be equal to N_{RF}. In such a case, the spreading matrix M may be an identity matrix or a unitary matrix. In case of the spreading matrix M being an identity matrix, a reference symbol s may be transmitted in N_{TX} time slots. At each time slot, one TX antenna may be used to transmit the reference symbol s, while other antennas may be switched off. Alternatively, the symbol s may be phase rotated from one time slot to other. The phase rotation pattern may be specified or signaled.

In case the spreading matrix M is a unitary matrix, a reference symbol s may be transmitted in N_{TX} time slots. At each time slot, each of the TX antennas may be used to transmit. The l^{th} antenna at time slot k may transmit a modulated reference symbol M_{l,k}s. Alternatively, the symbol s may be phase rotated from one time slot to other. The phase rotation pattern may be specified or signaled. The reference symbol s may be replaced by a sequence or set of sequences. For example, s may be equal to [c₁, c₂, . . . , cᵤ]. In the l^{th} antenna at the k^{th} time slot, a modulated sequence M_{l,k}s equal to [M_{l,k}c₁, M_{l,k}c₂, . . . , M_{l,k}cᵤ]. M_{l,k}s may be transmitted.

In an example N_{TX} may be greater than N_{RF}. In such a case, N_{RF} elements in the spreading matrix M may have non-zero values in each time slot. The spreading matrix M may be an identity matrix. In this case, a reference symbol s may be transmitted in N_{TX} time slots. At each time slot, one TX antenna may be used to transmit s, while other antennas may be switched off. Alternatively, the symbol s may be phase rotated from time slot to time slot. The phase rotation pattern may be specified or signaled. The spreading matrix M may be a matrix comprising one or more N_{RF}×N_{RF} submatrices. Each submatrix may be a unitary matrix. For example, if 2 RF chains and 4 antennas are available, then M may be equal to

$$[ \begin{matrix}{M}_{1} & 0 \\ 0 & {M}_{2}\end{matrix} ] ,$$

where M₁ and M₂ may be 2×2 unitary matrices. M₁ may or may not be the same as M₂. A reference symbol s may be transmitted using antenna 1 and antenna 2 in the first two time slots, and antenna 3 and antenna 4 in the last two time slots. The reference symbol s may be replaced by a sequence or set of sequences. For example, s may be equal to [c₁, c₂, . . . , cᵤ]. In the l^{th} antenna at the k^{th} time slot, a modulated sequence M_{l,k}s equal to [M_{l,k}c₁, M_{l,k}c₂, . . . , M_{l,k}cᵤ]. M_{l,k}s may be transmitted.

In an example, Nₐ may be equal to N_{TX} and N_{b} may be greater than N_{TX}. In this case, one time slot may not be enough to determine accurate channel state information for one channel coefficient. Accordingly, more than one time slots may be used for channel estimation.

In an example, Nₐ may be equal to N_{TX} and N_{b} may be less than N_{TX}. In this case, one time slot may be used to estimate more than one channel coefficient. For example, orthogonal training sequences may be used for different spatial streams in each time slot. The receiver may distinguish between them using auto-correlation or cross-correlation of the sequences. The receiver may recover more than one estimated channel coefficients.

FIG. 12 illustrates an exemplary transmission of reference signals and data over N_{TX} antennas. In this case, energy saving may be maintained by separating reference symbols and data symbols D in different time slots. The reference symbols 1202, 1204, and 1206 may be transmitted over each of the TX antennas or a subset of the TX antennas using N_{b} time units/slots. The data symbols may be transmitted using a spatial modulation scheme. The spatial modulation scheme may use the antenna index to convey information bits.

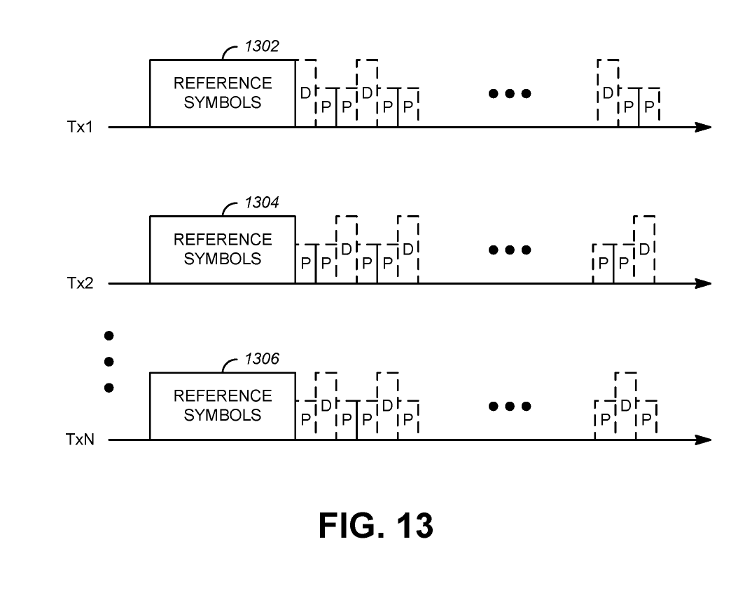

FIG. 13 illustrates an exemplary transmission of common reference symbol fields and pilot reference symbols. The reference signals may be transmitted using unused antennas. The common reference symbol fields 1302, 1304, and 1306 may be transmitted in a dedicated time slot before data transmission. The common reference symbol fields 1302, 1304, and 1306 may be transmitted as described herein. Fewer time slots may be allocated for the common reference symbol fields 1302, 1304, and 1306 compared to the transmission as illustrated in FIG. 12. Pilot reference symbols P may be transmitted with (e.g., interleaved with) the data transmission D. With a spatial modulation scheme, one or more antennas may be used to transmit normally modulated symbols, while other antennas may be muted. The selection of transmitting antennas may depend on the antenna index bits conveyed.

Muted antennas may be muted for data transmission but also used to carry pilot reference symbols. The data symbols and the pilot symbols may be distinguished by using one of the following. For example, the power of the data symbols and the pilot symbols may be adjusted. The pilot symbols may be transmitted with lower power. In an example, the modulation order of the data symbols and the pilot symbols may be adjusted. The pilot symbols may be transmitted with BPSK modulation while the data symbols may be transmitted with QPSK or higher order modulations. A sequence may be used on one or more pilots. A spreading sequence may be used on pilot transmission to aid recovery of the channel.

At the receiver, a successive interference cancellation receiver may be implemented. The data stream may be detected. The detected data stream may be corrected. The corrected data stream may help detect the rest of the pilot symbols and recover the channel state information.

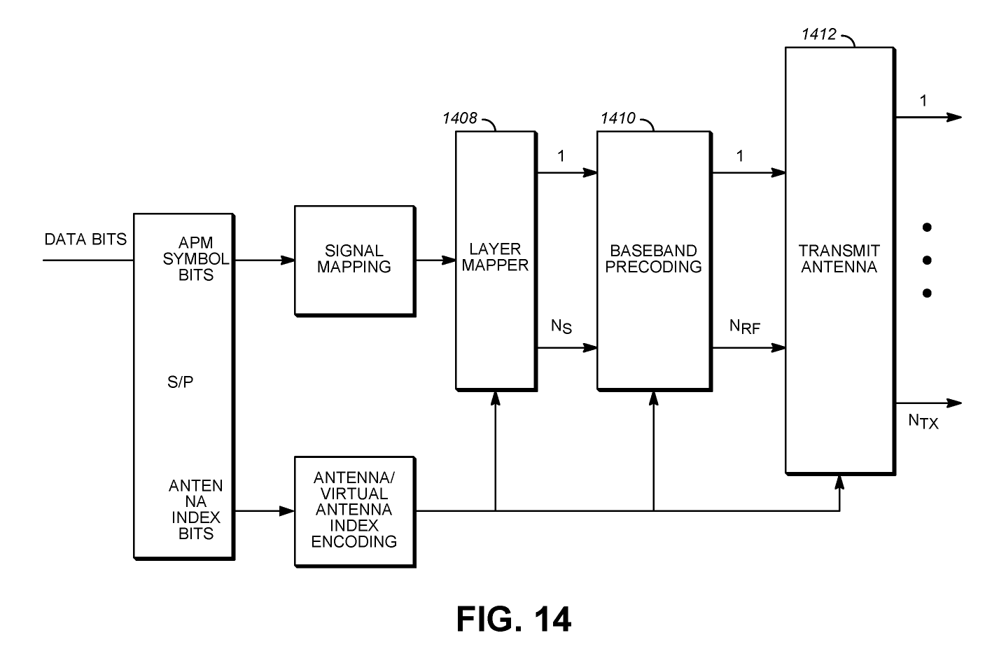

Channel estimation for hybrid spatial modulation is disclosed. Hybrid beamforming scheme may be combined with spatial modulation. FIG. 14 illustrates an exemplary hybrid spatial modulation system. As illustrated in FIG. 14, N_{TX} physical antennas and N_{RF} radio frequency frontend chains may be available at a transmit device. The transmit device may transmit Ns data streams using a type of modulation. The modulated symbols may be mapped to multiple layers in the layer mapping block 1408. For example, there may be Ns layers. In the baseband precoding block 1410, a baseband precoding operation may be applied to map Ns input symbols to generate N_{RF} output symbols. The N_{RF} symbols may be passed to an analog precoding operation and mapped to N_{TX} symbols which may be transmitted through N_{TX} antennas 1412. Extra antenna index bits may be carried by antenna or virtual antenna index encoding.

The virtual antenna index encoding algorithm may be performed. In an example, virtual antenna index encoding may be performed before baseband precoding. For example, a baseband precoder book may be specified or predefined and signaled between a transmitter and a receiver. The precoder book may contain K different precoding weights. Based on the value of coming antenna index bits, the transmitter may choose Ns precoding weights from the K in the codebook. The transmitter may transmit the modulated symbols on the Ns selected weights.

In an example, the virtual antenna index encoding algorithm may be performed after baseband precoding. For example, N_{used} RF chains may be selected based on the value of the antenna index bits obtained from a total N_{RF} RF chains. The output of baseband precoding operation may be N_{used} symbols instead of N_{RF} symbols. The N_{used} symbols may be allocated to the selected RF chains based on the value of the antenna index bits. In other examples, the virtual antenna index encoding may be performed before or after analog precoding.

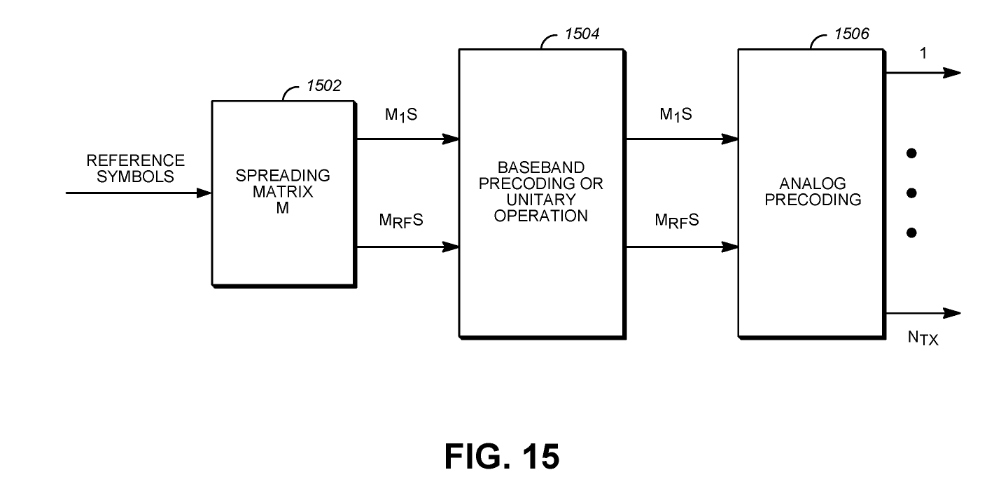

Reference symbols may be used by a receiver to estimate the channel from each of the possible transmit RF chains or TX antennas and to perform demodulation. FIG. 15 illustrates an example transmission diagram for reference symbols. Reference symbols may be passed to a spreading matrix M 1502 with a size Nₐ×N_{b}. The spreading matrix 1502 may be used to spread a reference symbol to time and spatial domains. A reference symbol s may be spread to Nₐ spatial streams and N_{b} time slots. The spreading matrix M 1502 may be specified in the standard or signaled, for example, signaled before a transmission. Both the transmitter and the receiver may know the spreading matrix. In an example, Nₐ may be equal to N_{RF}. The reference symbols may be transmitted over each of the RF chains. The reference symbols may be transmitted concurrently or sequentially. The reference symbols may be precoded or non-precoded.

In an example where virtual antenna index encoding is performed before baseband precoding, the reference signal may be transmitted using each of the precoding weights defined in a precoding book. In an example, the reference signal may be transmitted using each of the orthogonal (e.g., non-correlated) precoding weights defined in the precoding book. The rest of the weights may be constructed from the orthogonal (e.g., non-correlated) precoding weights. In an example, the reference signal may use a unitary matrix with size N_{RF}×N_{RF}. Using a unitary matrix may allow the receiver to estimate the N_{RF} virtual channel state information. The receiver may recover the precoded channel. Analog precoding block 1506 may be applied after baseband coding and/or unitary operation 1504.

In an example where virtual antenna index encoding may be performed after baseband precoding or before analog precoding, the reference signal may be transmitted by multiplying a unitary matrix of size N_{RF}×N_{RF}. This may allow the receiver to estimate the N_{RF} virtual channel state information. Analog precoding block 1506 may be applied after baseband coding and/or unitary operation 1504.

In an example where virtual antenna index encoding may be performed after analog precoding, the reference signal may not be precoded by the analog precoding block 1506. The reference signal may be transmitted through each of the possible TX antennas. Energy-saving operations using spatial modulation are disclosed. Various energy saving mechanisms are proposed that may provide higher energy saving and/or lower power consumption with spatial modulation. A two-dimensional multi-level DRX mechanism as disclosed herein may provide better energy saving by dynamic configuration of receiver RF chains and/or baseband (BB). The first dimension may be power saving in time domain and the second dimension may be power saving in transmission mode associated with SM.

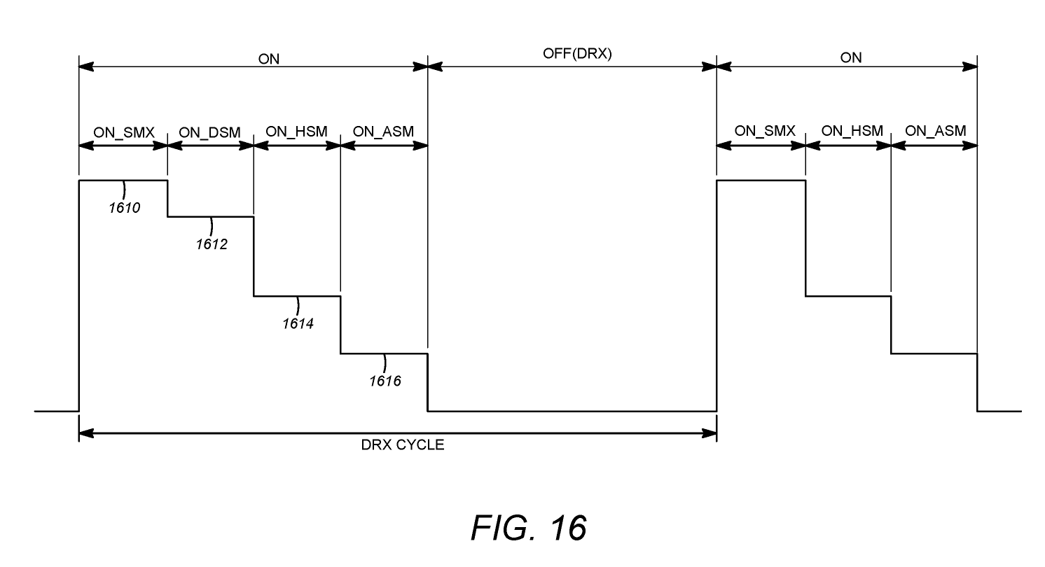

In an example, DRX control may be applied on a per SM type basis. Based on the type of spatial modulation, such as digital SM, hybrid SM, and/or analog SM different levels of power saving by switching on/off radio frequency (RF) and baseband (BB) circuitries may be provided as illustrated in FIG. 16. Various DRX control and DRX parameters/timers may be defined and configured for spatial multiplexing and various types of spatial modulations. DRX parameters/timers may include one or more of a DRX inactivity timer, a short DRX cycle, a long DRX cycle, a DRX short cycle timer, an on duration timer, or a DRX retransmission timer. DRX parameters or timers may be pre-defined for each type of spatial modulation. Once a specific type of spatial modulation is configured by an RRC or signaled by an L1 control channel, the corresponding DRX parameters or timers may be applied.

In an example, the same DRX control and DRX parameters or timers may be applied to each spatial modulation type. DRX parameters or timers may include one or more of a DRX inactivity timer, a short DRX cycle, a long DRX cycle, a DRX short cycle timer, an on duration timer, or a DRX retransmission timer. DRX parameters/timers may be pre-defined for each of the spatial modulation type.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

Although features and elements of the present specification consider LTE, LTE-A, New Radio (NR) or 5G specific protocols, it is understood that the solutions described herein are not restricted to this scenario and are applicable to other wireless systems as well.

1. A wireless transmit/receive unit (WTRU) comprising:
a processor configured to:
split a plurality of encoded data bits into amplitude phase modulation (APM) bits and virtual antenna index bits;
modulate the APM bits into modulated data symbols;
determine a virtual antenna port, wherein the virtual antenna port is determined based on the virtual antenna index bits and one precoding vector of a set of precoding vectors;
map the modulated data symbols to the transmission layer, wherein the modulated data symbols are mapped to the transmission layer based on the determined virtual antenna port; and
a transmitter configured to transmit the mapped modulated data symbols on the transmission layer.

2. The WTRU of claim 1, wherein the virtual antenna port is an indexed transmission layer.

3. The WTRU of claim 1, wherein the set of precoding vectors is preconfigured.

4. The WTRU of claim 1, wherein the set of precoding vectors is received via radio resource control (RRC) signaling or system information.

5. The WTRU of claim 1, wherein the set of precoding vectors is synchronized between the transmitter and a receiver.

6. The WTRU of claim 1, wherein the virtual antenna port comprises at least one pre-coded reference signal.

7. The WTRU of claim 1, wherein the processor is configured to select the set of precoding vectors based on information derived from the encoded data bits.

8. The WTRU of claim 1, further comprising:
a receiver configured to receive a set of feedback precoding vectors, and
wherein the processor is configured to select the set of precoding vectors based on the received set of feedback precoding vectors.

9. The WTRU of claim 1, wherein the set of precoding vectors is received via downlink control information carried on a control channel.

10. The WTRU of claim 9, wherein the control channel is one of a new radio physical downlink control channel (NR-PDCCH), a new radio enhanced physical downlink control channel (NR-E-PDCCH), or a new radio physical downlink shared channel (NR-PDSCH).

11. The WTRU of claim 1, wherein the set of precoding vectors is indicated via a reference signal.

12. A method for wireless communications, comprising:
splitting a plurality of encoded data bits into amplitude phase modulation (APM) bits and virtual antenna index bits;
modulating the APM bits into modulated data symbols;
determining a virtual antenna port, wherein the virtual antenna port is determined based on the virtual antenna index bits and one precoding vector of a set of precoding vectors;
mapping the modulated data symbols to the transmission layer, wherein the modulated data symbols are mapped to the transmission layer based on the determined virtual antenna port; and
transmitting the mapped modulated data symbols on the transmission layer.

13. The method of claim 12, wherein the virtual antenna port is an indexed transmission layer.

14-17. (canceled)

18. The method of claim 12, further comprising selecting the set of precoding vectors based on information derived from the encoded data bits.

19. The method of claim 12, further comprising:
receiving a set of feedback precoding vectors from a receiver; and
selecting the set of precoding vectors based on the received set of feedback precoding vectors.

20. The method of claim 12, wherein the set of precoding vectors is received via downlink control information carried on a control channel.

21. The method of claim 20, wherein the control channel is one of a new radio physical downlink control channel (NR-PDCCH), a new radio enhanced physical downlink control channel (NR-E-PDCCH), or a new radio physical downlink shared channel (NR-PDSCH).

22. (canceled)

23. A wireless transmit/receive unit (WTRU) comprising:
a processor configured to:
split a plurality of encoded data bits into amplitude phase modulation (APM) bits, virtual antenna index bits and physical antenna index bits;
modulate the APM bits into modulated data symbols;
determine a virtual antenna port, wherein the virtual antenna port is determined based on the virtual antenna index bits and one precoding vector of a set of precoding vectors;
determine a physical antenna port, wherein the physical antenna port is determined based on the physical antenna index bits;
map the modulated data symbols to at least one transmission layer, wherein the modulated data symbols are mapped based on the determined virtual antenna port; and
a transmitter configured to transmit the mapped modulated data symbols using the virtual antenna port via the physical antenna port.

24. (canceled)

25. The WTRU of claim 23, wherein the physical antenna port is based on an angle of arrival.

26-29. (canceled)

30. The WTRU of claim 23, wherein the processor is configured to select the set of precoding vectors based on information derived from the encoded data bits.

31-33. (canceled)
